(19) United States
(12) Patent Application Publication
(10) Pub. No.: US 2022/0277490 A1
(43) Pub. Date: Sep. 1, 2022

(54) IMAGE PROCESSING METHOD, IMAGE PROCESSING APPARATUS AND PROGRAM

(71) Applicant: NIPPON TELEGRAPH AND TELEPHONE CORPORATION, Tokyo (JP)

(72) Inventors: Yasue KISHINO, Tokyo (JP); Yoshinari SHIRAI, Tokyo (JP); Takayuki SUYAMA, Tokyo (JP); Shin MIZUTANI, Tokyo (JP)

(73) Assignee: NIPPON TELEGRAPH AND TELEPHONE CORPORATION, Tokyo (JP)

(21) Appl. No.: 17/636,835

(22) PCT Filed: Aug. 21, 2019
(86) PCT No.: PCT/JP2019/032663

§ 371 Date: Feb. 18, 2022

(51) Int. Cl. G06T 7/00

(52) U.S. Cl. CPC G06T 7/97; G06T 2207/10024

(57) ABSTRACT

Performing, by a computer, an identification procedure for identifying a partial region in a thermal image corresponding to a visible light image in accordance with a threshold for a temperature; and a processing procedure for processing the region of the visible light image identified in the identification procedure prevents privacy leakage from an image captured by a camera.

### TECHNICAL FIELD

The present invention relates to an image processing method, an image processing device, and a program.

### BACKGROUND ART

Many cameras are installed in our surroundings for various purposes such as monitoring for suspicious people or measuring effectiveness of digital signage. Most of these cameras are connected to networks and transmit captured image data to servers. At a transmission destination, a video is checked by a person, and a suspicious person is automatically identified.

As less expensive and smaller cameras become available, it can be assumed that more cameras will be installed at various places for various purposes in the future. In such environments, protecting privacy is an important problem. Cameras installed in public spaces may simultaneously take personal information unnecessary for their original purposes.

For example, to count the number of people standing in front of digital signage, a camera is assumed to be installed next to the digital signage (NPL 1). A video captured by the camera can easily display a face which is information with which individual can be identified. When the digital signage is used as a meeting place, there is a high possibility that a screen of a smartphone operated by a person who is waiting there is also shown in the video. Information with which a person can be identified (such as a face) or information which a person does not want to be seen in the first place (such as information displayed on a smartphone of an individual) is essentially unnecessary for measuring the effectiveness of digital signage. Nonetheless, the camera may collect information that can violate such privacy. Further, when such an image is transmitted to a server via a network, the risk of leaking such information increases. Therefore, in the effectiveness measurement of digital signage, a computer (such as a general-purpose computer) capable of image processing is installed in a field to transmit only processed results to the server and quickly erase processed images.

### CITATION LIST

### Non Patent Literature

NPL 1: Tetsuya Kinebuchi et al., Image Processing Technologies for Measuring Advertising Effectiveness of Digital Signage, NTT Technical Review, 2009

NPL 2: Yoshihisa Ijiri et al., Person Re-identification Algorithm, Technical Report of IEICE, PRMU (Pattern Recognition and Media Understanding), Vol. 111, No. 317, pp. 117 to 124, 2011

NPL 3: Yoshiaki Nishivai, Makoto Iida, Takeshi Naemura, Thermosaic: Automatic Obscure Effects Thermal Information, Journal of Institute of Image Information and Television Engineers, 59, 3, pp. 422 to 426, 2005

### SUMMARY OF THE INVENTION

### Technical Problem

However, installation of a computer with excellent image processing performance may cause another problem such as securing installation space or theft countermeasures. For purposes such as estimating a movement route of a person in accordance with images captured by a plurality of cameras (NPL 2), it is necessary to match the person taken by different cameras, and it is difficult for an image processing device at a camera side to perform all the processes in accordance with the purposes. In this case, it is considered practical for the camera side to perform only collection of images and a simple process and to transmit the images to a server, and for a server side to perform image processing in accordance with a purpose.

The present invention has been devised in view of the foregoing circumstances and an objective of the present invention is to prevent privacy leakage from images captured by a camera.

### Means for Solving the Problem

Accordingly, to solve the foregoing problems, a computer performs an image processing method including an identification procedure for identifing a partial region in a thermal image corresponding to a visible light image in accordance with a threshold for a temperature; and a processing procedure for processing the region of the visible light image identified in the identification procedure.

### Effects of the Invention

It is possible to prevent leakage of privacy from images captured by a camera.

### BRIEF DESCRIPTION OF DRAWINGS

FIG. 1 is a first diagram illustrating a specific example of a mask.

FIG. 2 is a second diagram illustrating a specific example of a mask.

FIG. 3 is a diagram illustrating a configuration example of a camera unit 1 according to an embodiment of the present invention.

FIG. 4 is a diagram illustrating a hardware configuration example of a sensor node unit 10 according to the embodiment of the present invention.

FIG. 5 is a diagram illustrating a functional configuration example of the camera unit 1 according to the embodiment of the present invention.

FIG. 6 is a flowchart illustrating an example of a processing procedure performed by the sensor node unit 10.

### DESCRIPTION OF EMBODIMENTS

Hereinafter, an embodiment of the present invention will be described with reference to the drawings. At present, to install a network camera, it is necessary to lay a cable for power feeding and communication. To simplify laying, one cable allows power feeding and communication in many cases, but still construction work or the like is required to lay the cable in many cases. In consideration of easiness of installation or the like, it is thought that a camera unit 1 that can be driven with a battery and has a wireless communication function will become widespread in the future.

In the camera unit 1, it is necessary to achieve the following to transmit an image to a server while solving the privacy problem described above.
1. Removal of privacy information from an image; and
2. Reduction in transmission cost of an image from which privacy information is removed That is, first of all, removal of privacy information is required from an image to be transmitted to a server. The removal of privacy information is enabled, for example, by processing (masking) a face shown in an image, a screen of a smartphone, or the like. However, in consideration of a process in a computational device which can run on a battery, it is necessary to use an algorithm which can be processed at a high speed even by a CPU with low power consumption.

Next, when a processed (masked) image (hereinafter referred to as a “masked image”) is transmitted to a server, transmission cost is considered to be reduced as much as possible, that is, an amount of transmission data needs to be reduced. This is because reducing the amount of data to be transmitted not only can assure a stable wireless communication bandwidth, but also expect to reduce power consumption associated with communication.

To achieve the foregoing two requirements, the camera unit 1 according to the embodiment includes a thermographic camera 22 in addition to a visible light camera 21.

To remove privacy information from an image, a thermosaic method proposed in NPL 3 is used. The thermosaic method is a method of applying a mosaic to a human region (or a non-human region) by utilizing the fact that a temperature is generally higher in a human region than in a surrounding region on a thermal image. In the embodiment, a function of realizing the thermosaic method is implemented on the camera unit 1. The use of the thermosaic method makes it possible to simply apply a mosaic or a mask to a face or the like with which an individual can be identified. When a thermal image can be prepared, an algorithm to apply a mosaic or a mask is simple and can be sufficiently processed by computational device with low power consumption.

A screen of a smartphone, a notebook computer, or the like, on which personal information can be displayed normally generates heat, and thus, the use of a thermal image captured with the thermographic camera 22 makes it possible to detect such a screen region.

According to the above description, as simple installation for removing privacy information, in the embodiment, a specific temperature is set as a threshold and a mask is applied to a partial region on a visible light image corresponding to the pixels at a temperature equal to or greater than the threshold in a thermal image (hereinafter referred to as a “mask region”).

For example, when a human face needs to be masked, a temperature around 30 degrees Celsius may be set as a threshold and a mask can be applied to a region (a part in which the skin such as the face is exposed) of a person with an average body temperature of about 36 degrees Celsius.

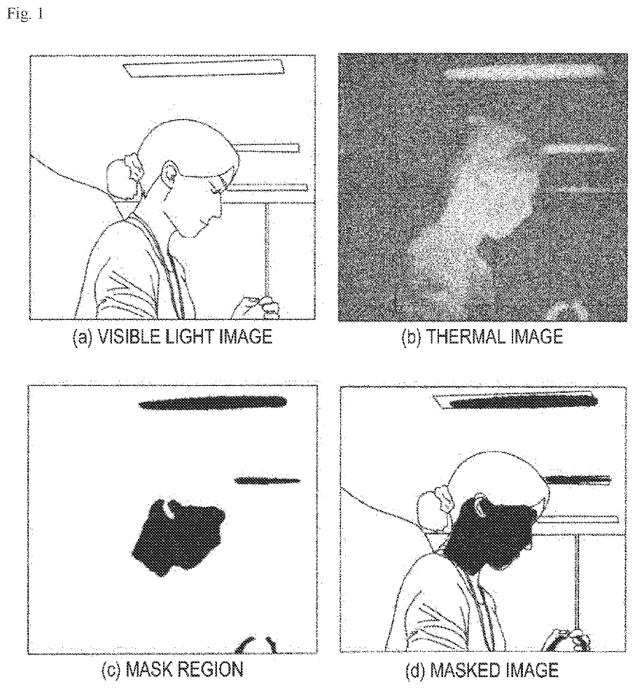

FIG. 1 is a first diagram illustrating a specific example of a mask. In FIG. 1, 1(a) illustrates a visible light image of a certain object person. 1(b) illustrates a thermal image captured at the same timing as a timing at which the object in 1(a) is imaged. 1(c) illustrates a mask region in which a temperature is equal to or greater than a threshold (30 degrees Celsius) in the thermal image in 1(b). 1(d) illustrates the masked image in which the mask region in 1(c) is masked in the visible light image in 1(a). In 1(d), the face of a person is masked.

For example, when a screen region of a smartphone needs to be masked, a temperature (hereinafter referred to as “α degrees Celsius”) slightly lower than a general temperature of a screen of the smartphone may be set to a threshold and a mask is applied to a region with a temperature equal to or greater than the threshold.

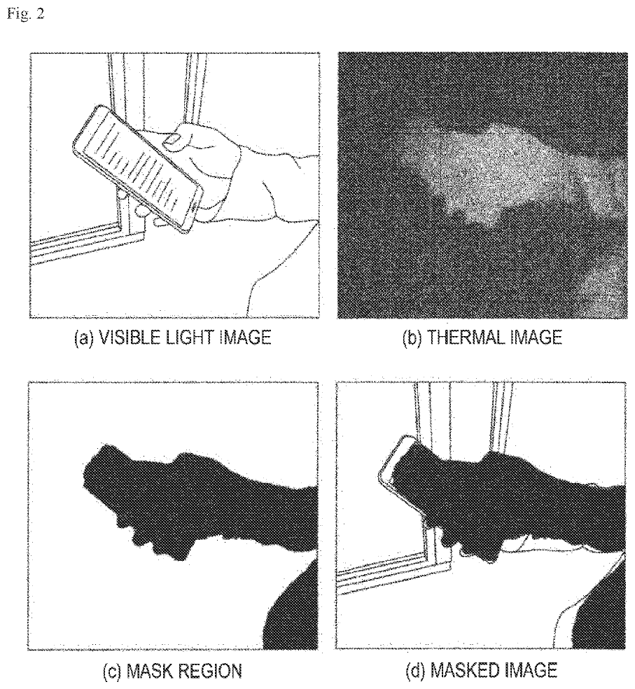

FIG. 2 is a second diagram illustrating a specific example of a mask. In FIG. 2, 2(a) illustrates a visible light image in which a smartphone is an object. 2(b) illustrates a thermal image captured at the same timing as a timing at which the object in 2(a) is imaged. 2(c) illustrates a mask region in which a temperature is equal to or greater than a threshold (α degrees Celsius) in the thermal image in 2(b). 2(d) illustrates the masked image in which the mask region in 2(c) is masked in the visible light image in 2(a). In 2(d), the screen of the smartphone is masked.

In (d) of FIG. 1, a region of a fluorescent lamp which is higher than 30 degrees Celsius is also masked. In (d) of FIG. 2, regions of an arm and a hand holding the smartphone and being a temperature greater than the α degrees Celsius are also masked. In this way, to avoid masking a region other than a region which needs to be masked originally, the threshold may have a range (an upper limit and a lower limit). For example, in the case of FIG. 1, when about 45 degrees Celsius is set as an upper limit and a region equal to or greater than 30 degrees Celsius and equal to or less than 45 degrees Celsius is set as a mask target, there is a probability of avoiding masking a portion of the fluorescent lamp.

To promote privacy protection, the visible light image before the masking is erased after the masked image is generated.

Further, in the embodiment, to reduce communication cost, the masked image is compressed. An existing compression technique such as JPEG or PNG may be used or a proprietary algorithm may be used for compression, and it is recommended that a mask using a compression property of an adopted algorithm be used in removing privacy information. For example, when PEG or the like is used, a compression property that, generally, the image features are less complicated as the compression algorithms adopted in these techniques have higher compression efficiency is used.

Huffman coding which is also adopted for JPEG or the like (https://ja.wikipedia.org/wiki/Huffman_coding) will be exemplified. In Huffman coding, the compression efficiency is higher as statistical deviation of data is higher. By assigning a short code to information that appears frequently and a long code to information that appears infrequently, it is possible to express the information with a smaller amount of data than data expressed using a code with a fixed length. From the viewpoint of an image, an image with a large number of pixels of the same color can be expected to have a high compression ratio by assigning a short code to that color. When such a property is used, a high compression ratio can be achieved by applying a monochromic mask in applying a mask to a portion equal to or greater than a given threshold in the thermosaic method described above. For example, when a visible light image and a masked image were compressed with JPEG at the same compression ratio, the visible light image was compressed to 208 KB and the masked image to 158 KB in FIG. 2.

In this method, a higher compression ratio can be achieved by calculating a color that appears frequently on the original visible light image and using that color as a color of a mask. However, in this case, the color that appears frequently in an image is identical to the color used for the mask, and thus, care should be taken when a mask region needs to be distinguished from the other region on the server side. A masking method should be selected in accordance with a purpose of using an image on the server side.

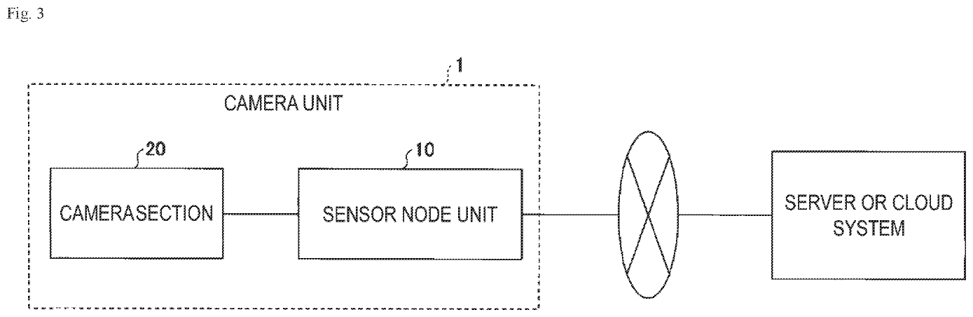

Hereinafter, the camera unit 1 that achieves the content described above will be described specifically. FIG. 3 is a diagram illustrating a configuration example of the camera unit 1 according to the embodiment of the present invention. In FIG. 3, the camera unit 1 includes a camera section 20 and a sensor node unit 10. The camera section 20 and the sensor node unit 10 are connected by one High-Definition Multimedia Interface (HDMI: registered trade name) cable with, for example, a maximum of about 1 m to 1.5 m to guarantee the degree of freedom of installation of the camera (the visible light camera 21 and the thermographic camera 22). The camera section 20 is a substrate that includes the visible light camera 21, the thermographic camera 22, and a microcomputer. The camera section 20 transmits a visible light image and a thermal image captured by the visible light camera 21 or the thermographic camera 22, and information indicating a temperature of the thermographic camera 22 itself (hereinafter referred to as “temperature information”) to the sensor node unit 10 connected by the cable.

The sensor node unit 10 is a substrate including a microcomputer or a computer such as a personal computer (PC). The sensor node unit 10 performs mask processing on the visible light image in accordance with the thermal image and the temperature information, and then transmits a masked image obtained as the processing result to a server, the cloud, or the like.

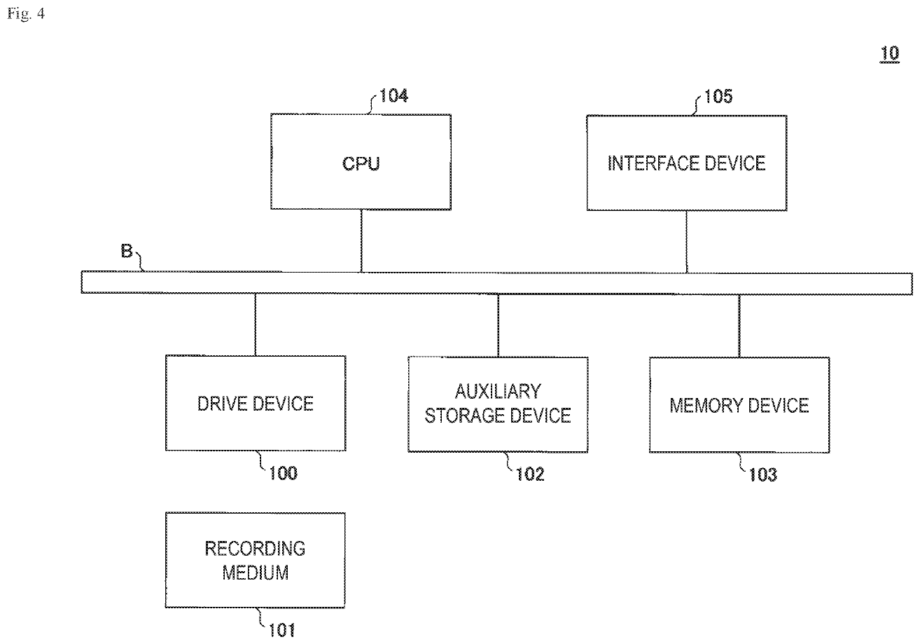

FIG. 4 is a diagram illustrating a hardware configuration example of the sensor node unit 10 according to the embodiment of the present invention. The sensor node unit 10 in FIG. 4 includes a drive device 100, an auxiliary storage device 102, a memory device 103, a CPU 104, and an interface device 105 connected to each other via a bus B.

A program that enables the sensor node unit 10 to process is provided via a recording medium 101 such as a CD-ROM. When the recording medium 101 that stores a program is set in the drive device 100, the program is installed on the auxiliary storage device 102 from the recording medium 101 via the drive device 100. However, a program may not necessarily be installed from the recording medium 101, and the program may be downloaded from another computer via a network. The auxiliary storage device 102 stores the program installed and a necessary file, data, and the like.

When an instruction to activate the program is given, the memory device 103 reads the program from the auxiliary storage device 102 and stores the program. The CPU 104 performs a function related to the sensor node unit 10 in accordance with the program stored in the memory device 103. The interface device 105 is used as an interface for connection to a network.

The sensor node unit 10 may be a computer such as a personal computer (PC) or may be a substrate or the like in which a microcomputer is embedded.

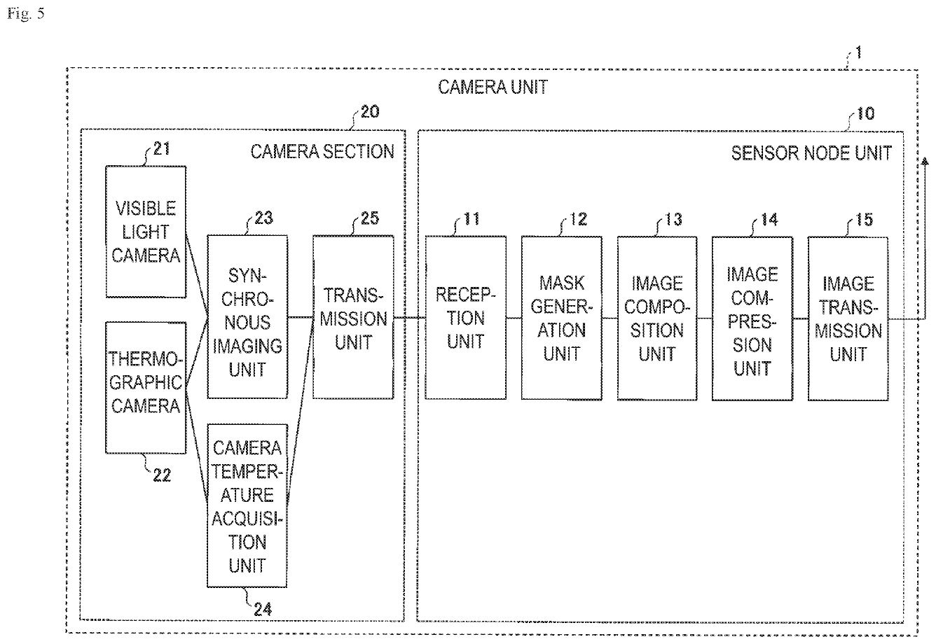

FIG. 5 is a diagram illustrating a functional configuration example of the camera unit 1 according to the embodiment of the present invention. In FIG. 5, the camera section 20 includes a visible light camera 21, a thermographic camera 22, a synchronous imaging unit 23, a camera temperature acquisition unit 24, and a transmission unit 25. Of these units, the synchronous imaging unit 23, the camera temperature acquisition unit 24, and the transmission unit 25 are enabled through processes which the program installed in the microcomputer of the camera section 20 causes the microcomputer to perform.

The synchronous imaging unit 23 synchronizes the visible light camera 21 with the thermographic camera 22 to perform imaging. As a result, a visible light image and a thermal image are captured at the same timing. The synchronous imaging unit 23 acquires a visible light image through a mobile industry processor interface (MIPI) from the visible light camera 21 and acquires a thermal image through a serial peripheral interface (SPI) from the thermographic camera 22.

The camera temperature acquisition unit 24 acquires temperature information indicating a temperature of the thermographic camera 22 itself. The transmission unit 25 collectively transmits the visible light image, the thermal image, and the temperature information to the sensor node unit 10.

On the other hand, the sensor node unit 10 includes a reception unit 11, a mask generation unit 12, an image composition unit 13, an image compression unit 14, and an image transmission unit 15. These units are achieved through processes which one or more programs installed in the sensor node unit 10 cause the CPU 104 to perform.

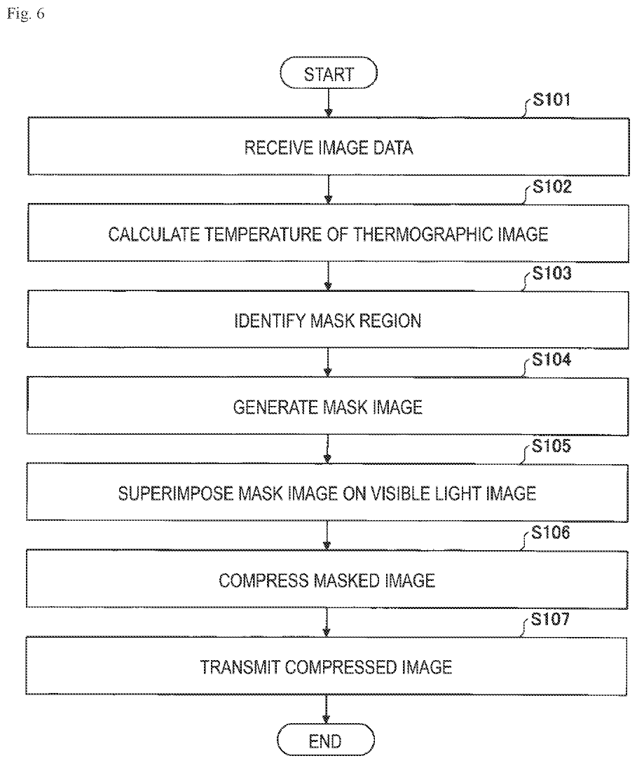

Hereinafter, a processing procedure performed by the sensor node unit 10 will be described. FIG. 6 is a flowchart illustrating an example of a processing procedure performed by the sensor node unit 10.

When the reception unit 11 receives data (the visible light image, the thermal image, and the temperature information) transmitted from the camera section 20, the reception unit 11 loads the data into a memory (S101).

Subsequently, the mask generation unit 12 calculates an actual temperature of each pixel of the thermal image (hereinafter simply referred to as a “temperature”) in accordance with the temperature information (S102). The temperature of each pixel of the thermal image can be calculated using a known method.

Subsequently, the mask generation unit 12 identifies a mask region by comparing the temperature calculated for each pixel of the thermal image with a threshold (S103). As described above, for example, a region of the pixels whose temperature is equal to or greater than the threshold is identified as a mask region.

Subsequently, the mask generation unit 12 generates an image for applying a mask to the mask region (that is, an image formed by the pixels included in the mask image) (hereinafter referred to as a “mask image”) (S104). As described above, the mask image may be generated so that a high compression ratio can be achieved. For example, a mask image may be generated as a monochromic image.

Subsequently, the image composition unit 13 generates a masked image in which the mask region in the visible light image is shaded with the mask image by superimposing the mask image generated by the mask generation unit 12 on the visible light image captured by the visible light camera 21 (S105). At this time, in addition to the shading by simple superimposition of an image, the image composition unit 13 may perform a process of applying a blur or a mosaic to a portion (region) designated in the mask image in the visible light image so that an original image (such as a human face) in that portion is not able to be identified.

Subsequently, the image compression unit 14 compresses the masked image (S106). A compression algorithm has been described above. Subsequently, the image transmission unit 15 transmits the compressed masked image to a predetermined server, cloud system, or the like via a network (S107).

In addition to the compression of the masked image, the image compression unit 14 may extract only a feature so that an object shown in the visible light image before the masking is not specifically identified and compress the feature as additional information along with the masked image for convenience of a transmission destination (such as a server or a cloud system) of the compressed masked image. In this way, the server, the cloud system, or the like can obtain supplementary information regarding the image processing of the visible light image in which an amount of information is lost due to the masking.

As described above, according to the embodiment, the mask region is identified in accordance with the thermal image corresponding to the visible light image and the mask region in the visible light image is processed (changed). As a result, a portion in which privacy may be violated can be processed (a mask is applied to the portion) in the visible light image. Accordingly, it is possible to prevent privacy leakage from an image captured by the camera.

By selecting a mask expression appropriate for the compression and generating a mask image, it is possible to reduce an amount of data to be transmitted.

Hereinafter, specific application examples of the embodiment will be described.

### APPLICATION EXAMPLE 1

### Counting the Number of People, Tracking People Flow

Counting the number of people that are in a certain space or tracking a people flow is a typical application example of monitoring by using a camera. In the embodiment, faces, hands, or the like of people are shaded and the captured visible light images are transmitted to a sever as they are, and thus, it is thought that the embodiment can also be applied to an algorithm for counting the number of people or tracking a people flow in an existing algorithm. This is because the existing algorithm determines people by using the shape of people, colors of clothes, or the like. However, some algorithms use information regarding contours of people, and thus in such algorithms, there is a probability of an originally non-existent contour being extracted due to shading. Accordingly, it is thought that the image composition unit 13 can extract the same person while protecting privacy if an algorithm is slightly adjusted by blurring a central portion of a face (a mask region) instead of shading the mask region. For an algorithm in which supervised learning is used, it is thought that a person can be detected if shaded images are prepared as training data and transfer learning is finished in advance.

### APPLICATION EXAMPLE 2

### Improvement in Accuracy of Image Region Division by Using Thermal Image

In a thermal image, there is a high probability that when a displayed object is changed, the temperature will also change. Accordingly, in an application in which a region in a target object shown in an image is divided for identification, there is a probability of a region being divided with higher accuracy than in an algorithm of the related art for dividing a region using only a visible light image by performing a process of matching a thermal image with a visible light image. In this way, according to the embodiment, image processing can be performed at higher accuracy than when only an existing visible light image is used, not only by hiding a region in which there is a privacy problem but also by combining two cameras.

### APPLICATION EXAMPLE 3

### Extracting Depth Information

In a stereo camera, depth information of an object shown on a screen can be extracted using a parallax between images acquired from two cameras placed next to each other. In the embodiment, since the visible light camera 21 and the thermographic camera 22 are disposed near to each other, the information can also be ascertained with two camera images with a parallax. Since a visible light image and a thermal image are captured with different colors despite being of the identical object, an algorithm dedicated for a stereo camera in the related art cannot be simply used, but as long as a correspondence relation between regions of a visible light image and a thermal image can be acquired by deep learning or the like, it is thought that depth information can be acquired.

In the embodiment, the sensor node unit 10 is an example of an image processing device. The mask generation unit 12 is an example of an identification unit. The image composition unit 13 is an example of a processing unit.

The embodiments of the present invention have been described above in detail, but the present invention is not limited to such specific embodiments, and various modifications and changes can be made within the scope of the gist of the present invention described in the claims.

### REFERENCE SIGNS LIST

10 Camera unit
10 Sensor node unit 10 unit
11 Reception unit
12 Mask generation unit
13 Image composition unit
14 Image compression unit
15 Image transmission unit
20 Camera section
21 Visible light camera
22 Thermographic camera
23 Synchronous imaging unit
24 Camera temperature acquisition unit
25 Transmission unit
100 Drive device
101 Recording medium
102 Auxiliary storage device
103 Memory device
104 CPU
105 Interface device
B Bus

1. An image processing method performed by a computer, the method comprising:
identifying a partial region in a thermal image corresponding to a visible light image in accordance with a threshold for a temperature; and
processing a region of the visible light image corresponding to the partial region of the thermal image identified by the identifying.

2. The image processing method according to claim 1, wherein
the processing makes the region monochrome.

3. An image processing device: configured to:
identify a partial region in a thermal image corresponding to a visible light image in accordance with a threshold for a temperature; and
process a region of the visible light image corresponding to the partial region of the thermal image identified by the identification unit.

4. The image processing device according to claim 3, further configured to:
process the region of the visible light image to make the region monochrome.

5. A non-transitory computer-readable medium having computer-readable instructions stored thereon, which, when executed, cause a computer including a memory and a processor to execute a set of operations, comprising:
identifying a partial region in a thermal image corresponding to a visible light image in accordance with a threshold for a temperature; and
processing a region of the visible light image corresponding to the partial region of the thermal image identified by the identifying.

6. The image processing method according to claim 1, wherein processing the region of the visible light image generates a masked image having a smaller size than the visible light image.

7. The image processing method according to claim 6, further comprising transmitting the masked image to a remote server.

8. The image processing method according to claim 1, wherein the region of the visible light image is masked using a frequent color of the visible light image.

9. The image processing method according to claim 1, wherein:
the thermal image is obtained from a thermographic camera; and
the visible light image is obtained from a visible light camera.

10. The image processing method according to claim 1, wherein:
the threshold for the temperature corresponds to a body temperature of a person; and
the region of the visible light image includes a human face.

11. The image processing method according to claim 1, wherein:
the threshold for the temperature corresponds to a temperature lower than a general temperature of a device; and
the region of the visible light image includes a screen of the device.

12. The image processing device according to claim 3, wherein processing the region of the visible light image generates a masked image having a smaller size than the visible light image.

13. The image processing device according to claim 12, further configured to transmit the masked image to a remote server.

14. The image processing device according to claim 3, further configured to mask the region of the visible light image using a frequent color of the visible light image.

15. The image processing device according to claim 3, wherein:
the threshold for the temperature corresponds to a body temperature of a person; and
the region of the visible light image includes a human face.

16. The image processing device according to claim 3, wherein:
the threshold for the temperature corresponds to a temperature lower than a general temperature of a device; and
the region of the visible light image includes a screen of the device.

17. The non-transitory computer-readable medium according to claim 5, wherein:
processing the region of the visible light image generates a masked image having a smaller size than the visible light image; and
the method further comprises transmitting the masked image to a remote server.

18. The non-transitory computer-readable medium according to claim 5, wherein the region of the visible light image is masked using a frequent color of the visible light image.

19. The non-transitory computer-readable medium according to claim 5, wherein:
the threshold for the temperature corresponds to a body temperature of a person; and
the region of the visible light image includes a human face.

20. The non-transitory computer-readable medium according to claim 5, wherein:
the threshold for the temperature corresponds to a temperature lower than a general temperature of a device; and
the region of the visible light image includes a screen of the device.
